(19) United States
(12) Patent Application Publication
(10) Pub. No.: US 2026/0233518 A1
(43) Pub. Date: Aug. 13, 2026

(54) LIQUID EJECTION HEAD AND LIQUID EJECTION APPARATUS

(71) Applicant: CANON KABUSHIKI KAISHA, Tokyo (JP)

(72) Inventors: TAKEHO MIYASHITA, Kanagawa (JP); YUJI TAMARU, Tokyo (JP); YOSUKE TAKAGI, Kanagawa (JP); SHIMPEI YOSHIKAWA, Kanagawa (JP); YASUAKI KITAYAMA, Kanagawa (JP)

(21) Appl. No.: 19/537,069

(22) Filed: Feb. 11, 2026

(30) Foreign Application Priority Data
Feb. 13, 2025 (JP) 2025-021760
Dec. 4, 2025 (JP) 2025-231133

(51) Int. Cl. B41J 2/14; B41J 2/165

(52) U.S. Cl. CPC B41J 2/14; B41J 2/1433; B41J 2/16508

(57) ABSTRACT

A liquid ejection head of the present disclosure includes a housing including a first channel for supplying the liquid to the liquid ejection unit and a second channel for collecting the liquid from the liquid ejection unit; and a liquid circulation unit including a supply port, a collection port, a pump, and a third channel connecting the supply port and the collection port via the pump. The housing includes a concave portion including a bottom surface and a side wall connected to the bottom surface, the liquid circulation unit is disposed in the concave portion, and a maximum volume of liquid containable in the concave portion in a use state of the liquid ejection head is larger than a volume of liquid containable in an entirety of the third channel of the liquid circulation unit.

### BACKGROUND

### Field of the Technology

The present disclosure relates to a liquid ejection head capable of circulating inks and to a liquid ejection apparatus using this liquid ejection head.

### Description of the Related Art

In the field of inkjet printers in recent years, there has been a demand for ink circulation-type liquid ejection apparatuses capable of using special inks for recording media for outputting print products with high image quality. There has been a similar demand for a type of liquid ejection apparatus that scans a liquid ejection head.

With the above liquid ejection apparatus, which scans a liquid ejection head, it is desirable that the ink circulation is complete within the head from the viewpoint of the effect of sloshing and the like. Japanese Patent Laid-Open No. 2018-30350 (hereinafter referred to as Patent Document 1) discloses a configuration in which components required for ink circulation such as a pump, a pressure adjustment mechanism, a pump driving circuit board, and a sub tank are disposed in a head in order to make the ink circulation path complete within the head.

### SUMMARY

Further reliability is required for liquid ejection heads.

A liquid ejection head according to the present disclosure includes: a liquid ejection unit configured to eject a liquid; a housing including a first channel for supplying the liquid to the liquid ejection unit and a second channel for collecting the liquid from the liquid ejection unit; and a liquid circulation unit including a supply port for supplying the liquid to the first channel, a collection port for collecting the liquid from the second channel, a pump configured to supply the liquid collected from the collection port to the supply port, and a third channel connecting the supply port and the collection port via the pump, in which the housing includes a concave portion including a bottom surface and a side wall connected to the bottom surface, the liquid circulation unit is disposed in the concave portion, and a maximum volume of liquid containable in the concave portion in a use state of the liquid ejection head is larger than a volume of liquid containable in an entirety of the third channel of the liquid circulation unit.

Features of the present disclosure will become apparent from the following description of embodiments with reference to the attached drawings. The following description of embodiments is described by way of example.

### BRIEF DESCRIPTION OF THE DRAWINGS

FIG. 1A is a diagram illustrating a liquid ejection apparatus according to the present disclosure and is a schematic configuration diagram of the liquid ejection apparatus according to the present disclosure;

FIG. 1B is a diagram illustrating the liquid ejection apparatus according to the present disclosure and is a block diagram of a control system of the liquid ejection apparatus according to the present disclosure;

FIG. 2 is an exploded perspective view of a liquid ejection head according to the present disclosure;

FIG. 3 is a schematic exterior view of a liquid circulation unit of the liquid ejection head according to the present disclosure;

FIG. 4 is a schematic cross-sectional view of an ink circulation path in the liquid ejection head according to the present disclosure;

FIG. 5 is a schematic diagram of the ink circulation path in the liquid ejection head according to the present disclosure;

FIG. 6 is a schematic view illustrating connection of a driving wiring for a circulation pump of the liquid ejection head according to the present disclosure;

FIG. 7 is a schematic diagram illustrating a cross-sectional view of a head electric substrate of the liquid ejection head according to the present disclosure;

FIG. 8 is a top view of the liquid ejection head according to the present disclosure without a head cover;

FIG. 9 is a perspective view of the liquid ejection head according to the present disclosure without the head cover;

FIG. 10 is a schematic cross-sectional view taken along line X-X in FIG. 8;

FIG. 11 is a schematic cross-sectional view taken along line XI-XI in FIG. 10 without the head electric substrate;

FIG. 12 is a schematic cross-sectional view of the liquid ejection head according to the present disclosure and is a diagram illustrating a case where the liquid ejection head includes one circulation unit;

FIG. 13 is a schematic cross-sectional view of a liquid ejection head in a second embodiment of the present disclosure;

FIG. 14 is a schematic cross-sectional view taken along line XIV-XIV in FIG. 13; and

FIG. 15 is a schematic cross-sectional view of a liquid ejection head in a third embodiment of the present disclosure.

### DESCRIPTION OF THE EMBODIMENTS

Liquid ejection heads and liquid ejection apparatuses using the same according to the present disclosure will now be described with reference to the drawings. In the description in this specification, directions may be defined by an X axis, a Y axis, and a Z axis. These axes are indicated by directional axes with arrows illustrated in drawings. In a case where arrows pointing in opposite directions indicate the direction of an axis, it represents that the object may move in both the "+" and "−" directions of that axis.

In this specification, in a case of specifying the direction of each axis, the direction in which the arrow on the X, Y, or Z axis points is defined as the "+" direction of the axis. That is, the "+" and "−" directions of each axis are such that the "+" direction is the direction in which the arrow points while the "−" direction is the direction opposite to the direction in which the arrow points. Moreover, in a case of referring to the direction of an axis without specifying the "+" or "−" direction, it is simply referred to as the "X axis direction," "Y axis direction," or "Z axis direction."

In this specification, the terms "liquid" and "ink" are used. These terms are concepts encompassing any liquids that can be used for recording. Moreover, the terms "liquid" and "ink" represent any liquids that can be used to form an image or to process a recording medium by being applied to the recording medium. Accordingly, in this specification, the terms "liquid" and "ink" are used interchangeably. Also, in this specification, the concept of recording is not particularly limited and is applicable to industrial uses and the like. For example, the concept of recording is usable in applications such as fabrication of biochips, printing of electronic circuits, and fabrication of semiconductor substrates.

### First Embodiment

A liquid ejection head according to a first embodiment of the present disclosure will be described with reference to drawings together with the configuration of a liquid ejection apparatus including the liquid ejection head. In the following, an overview of a liquid ejection apparatus according to the present disclosure will be described and then a liquid ejection head according to the present disclosure will be described.

### Liquid Ejection Apparatus

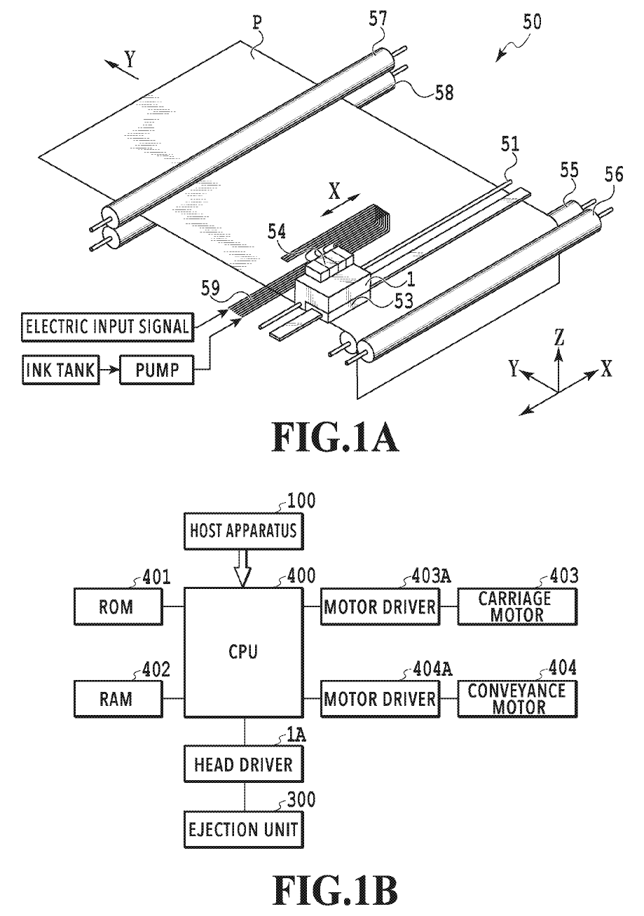

FIGS. 1A and 1B illustrate a liquid ejection apparatus including a liquid ejection head according to the present disclosure. FIG. 1A is a schematic perspective view illustrating an example configuration of a liquid ejection apparatus using a liquid ejection head 1. FIG. 1B is a block diagram illustrating a control system of the liquid ejection apparatus.

A liquid ejection apparatus 50 in the present embodiment will be described with reference to FIG. 1A. The liquid ejection apparatus 50 in the present embodiment is a serial scan-type apparatus that ejects inks from the liquid ejection head 1 to record an image on a recording medium P (e.g., an inkjet liquid ejection apparatus). The liquid ejection apparatus 50 in the present embodiment includes the liquid ejection head 1, a guide shaft 51, a carriage 53, a liquid circulation unit 54, conveyance rollers 55, 56, 57, and 58, guides 59, an electric wiring board (not illustrated), ink tanks, pumps, and so on. The electric wiring board generates electric input signals for driving ejection energy generation elements. The ink tanks store inks, and the pumps supply the inks from the ink tanks.

The liquid ejection head 1 is an inkjet liquid ejection head and mounted on the carriage 53. The carriage 53 moves along the guide shaft 51 in a main scanning direction along arrow X illustrated in FIG. 1A. The conveyance rollers 55, 56, 57, and 58 convey the recording medium P in a sub scanning direction along arrow Y intersecting the main scanning direction indicated by arrow X (in the example of the present embodiment, a direction orthogonally intersecting the X direction). In the liquid ejection apparatus in the present embodiment, electric wirings, ink and air pipes necessary for liquid ejection are supplied to the carriage 53 through the guides 59. The liquid ejection head 1 is equipped with the liquid circulation unit 54, with which inks are circulated through an ejection unit 300 to be described later. The ejection unit 300 includes ejection energy generation elements. The ejection energy generation elements are driven by a head driver 1A in accordance with electric input signals from the electric wiring board.

The liquid ejection head 1 is capable of performing full-color printing with liquids such as cyan (C), magenta (M), yellow (Y), and black (K) inks. In the liquid ejection apparatus in the present embodiment, a cap member is disposed at a position outside the conveyance path for the recording medium P. While a recording operation is not performed, this cap member moves relative to a position at which it covers the orifice face of the liquid ejection head 1 and performs a suction operation to prevent drying of the ejection orifices and fill the liquids such as the inks or recover the condition of the liquid ejection head, or the like.

Next, the control system of the liquid ejection apparatus will be described with reference to FIG. 1B. The control system in the present embodiment mainly includes the following constituent elements. Specifically, the control system includes a central processing unit (control unit) 400, a read-only memory (ROM) 401 holding programs, such as the procedures of processes, and a random-access memory (RAM) 402. The control system also includes a carriage motor 403 for moving the carriage 53, a first motor driver 403A which controls the carriage motor 403, a conveyance motor 404 for conveying the recording medium P, and a second motor driver 404A which controls the conveyance motor 404. The control system additionally includes the ejection unit 300 and the head driver 1A, which controls this ejection unit.

In the present embodiment, the CPU (control unit) 400 controls the liquid ejection apparatus 50 based on the programs, such as the procedures of processes, stored in the ROM 401. The RAM 402 is used as a work area or the like for executing those processes. The CPU 400 controls the head driver 1A based on image data from a host apparatus 100 provided outside the liquid ejection apparatus 50. The CPU 400 controls the carriage motor 403 for moving the carriage 53 via the first motor driver 403A, and controls the conveyance motor 404 for conveying the recording medium P via the second motor driver 404A.

### Description of Configuration of Liquid Ejection Head

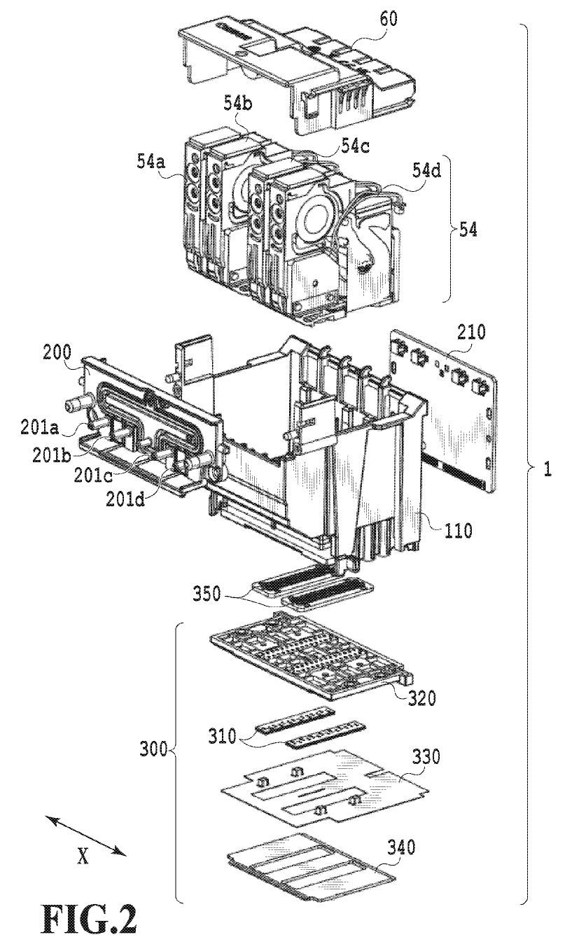

A liquid ejection head according to the present disclosure will be described with reference to FIG. 2. FIG. 2 illustrates an exploded perspective view of the liquid ejection head 1 in the present embodiment. As illustrated in FIG. 2, the liquid ejection head 1 includes the liquid circulation unit 54, a housing 110, a joint member 200, a head electric substrate 210, a head cover 60, the ejection unit 300, seal members 350, and so on.

The liquid circulation unit 54 includes individual liquid circulation units 54a, 54b, 54c, and 54d for respective inks (hereinafter referred to also as "individual liquid circulation units 54a to 54d"). Each of the individual liquid circulation units 54a to 54d is connected to the housing 110 and the joint member 200 to be described later. Note that FIG. 2 illustrates a case where the number of individual liquid circulation units is four, but the number of individual liquid circulation units is not limited and may be changed according to the number of types of inks to be set or the like. Also, in this specification, one of the individual liquid circulation units 54a to 54d for one type of ink employed in the liquid ejection head in the present embodiment may be described to represent each individual liquid circulation unit. In such a case, in this specification, the one of the individual liquid circulation units 54a to 54d may be referred to as "liquid circulation unit 54."

The housing 110 includes a concave portion formed by its bottom surface and side walls. The individual liquid circulation units 54a to 54d of the liquid circulation unit 54 are disposed in this concave portion. In the liquid ejection head according to the present disclosure, the height of the circulation unit can be larger than the height of the side walls of the housing 110.

The head cover 60 is mounted to the top of the housing 110. Further, the joint member 200 for supplying liquids (e.g., inks) to the liquid circulation unit 54 from the body of the liquid ejection apparatus is attached to the housing 110. The joint member 200 includes individual joint needles 201a, 201b, 201c, and 201d (hereinafter referred to also as "individual joint needles 201a to 201d") for the individual liquid circulation units 54a to 54d, respectively. In a case where the liquid ejection head is mounted to the liquid ejection apparatus, supply tubes (not illustrated) for the inks are connected respectively to the individual joint needles 201a to 201d from the recording apparatus body side. The inks are supplied from the supply tubes to the individual liquid circulation units 54a to 54d through the individual joint needles 201a to 201d, respectively.

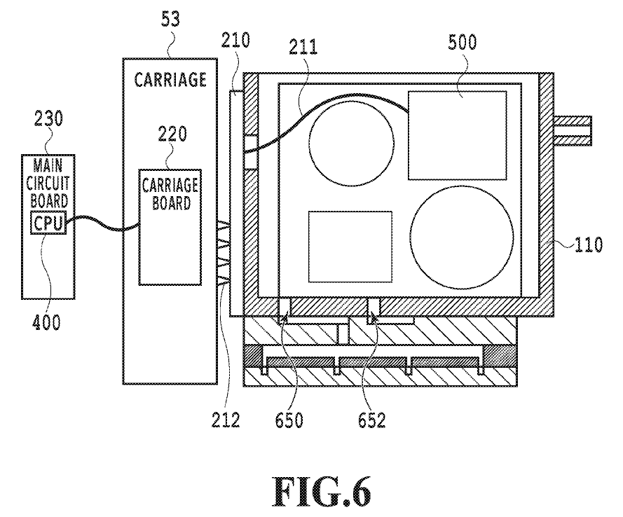

The ejection unit 300 is connected to the bottom surface of the housing 110. The inks supplied to the liquid circulation unit 54 pass through channels inside the housing 110 (e.g., a first channel 650 and a second channel 652 illustrated in FIG. 6) and are supplied to and collected from the ejection unit 300. The ejection unit 300 includes ejection elements 310 including actuators for ejecting the inks, a support member 320, an electric wiring board 330 for sending electric signals to the ejection elements, and a cover member 340 covering the electric wiring board. The ejection elements 310 and the electric wiring board 330 are adhesively fixed to the support member 320. Further, the cover member 340 is adhesively joined to cover the surface of the support member 320. The ejection elements 310 and the electric wiring board 330 are electrically connected by wire bonding. Note that the method for the electrical connection may be flying lead bonding or the like. The cover member 340 includes openings at portions corresponding to the ejection elements 310. The ejection unit 300 and the housing 110 are joined with the seal members 350 interposed therebetween. The joining is performed by screwing the support member 320 of the ejection unit 300 to the housing 110. Note that the ejection unit 300 and the housing 110 may be joined using an adhesive agent.

The surface of the housing 110 on the opposite side from the joint member 200 side is a contact surface. The head electric substrate 210, which receives electric signals from the main body, is connected to the contact surface. The electric signals are sent to the ejection elements 310 from the head electric substrate 210 through the electric wiring board 330 of the ejection unit 300. Here, the head electric substrate 210 and the housing 110 may be connected by fixing using riveting, an adhesive agent, or a two-sided adhesive tape. The head electric substrate 210 and the electric wiring board 330 are electrically connected by pressure bonding using an anisotropic conducting film (ACF). This electric connection may be performed by wire bonding or flying lead bonding.

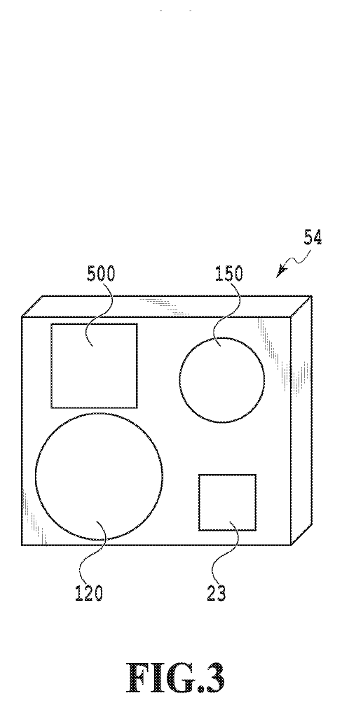

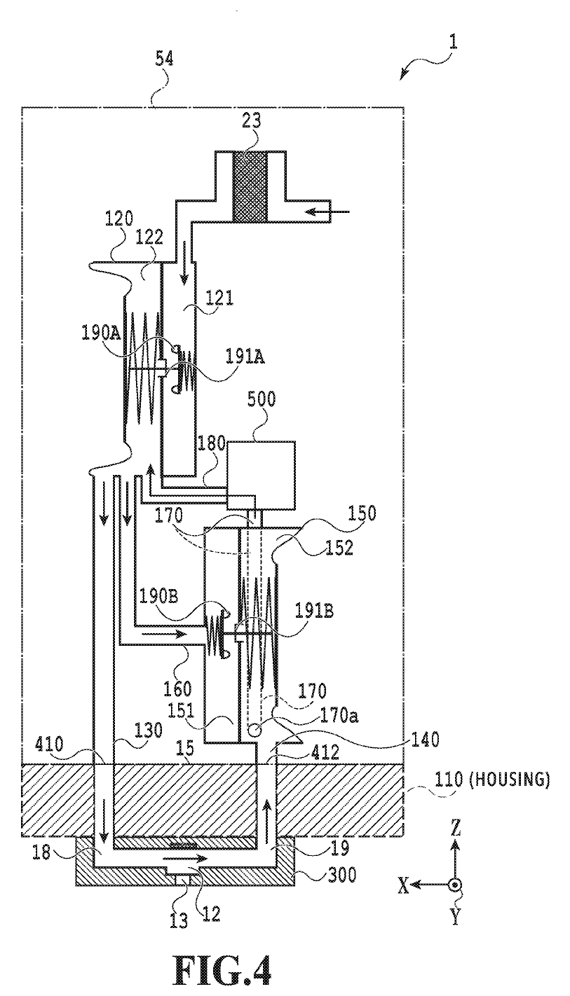

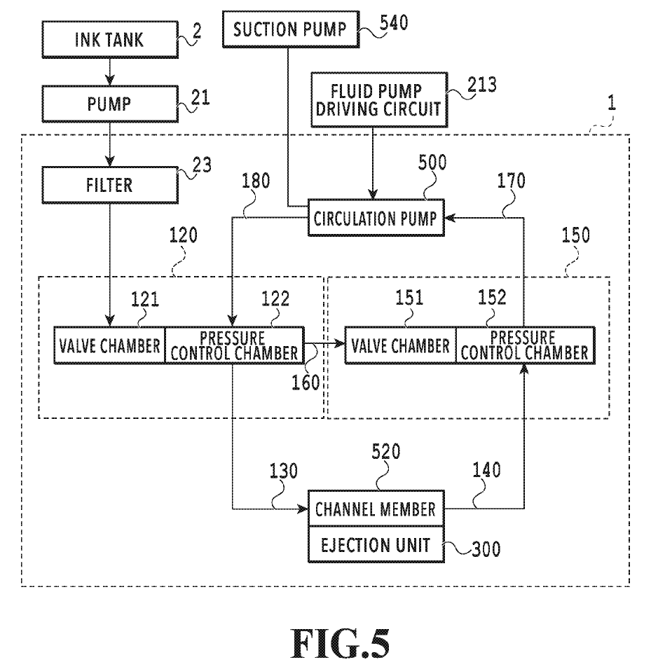

FIG. 3 is a schematic exterior view of one liquid circulation unit 54 for one type of liquid (e.g., ink) used in the liquid ejection apparatus in the present embodiment (one of the individual liquid circulation units 54a to 54d). The liquid circulation unit 54 can include a filter 23, a first pressure adjustment unit 120, and a second pressure adjustment unit 150 as well as a circulation pump 500. These constituent elements are connected by channels as illustrated in FIGS. 4 and 5 to thereby form a circulation path for supplying and collecting the ink to and from the ejection unit 300 inside the liquid ejection head 1.

FIG. 4 is a vertical cross-sectional view schematically illustrating the circulation path for one type of ink (ink of one color) formed inside the liquid ejection head 1. The relative positions of the components in FIG. 4 (such as the first pressure adjustment unit 120, the second pressure adjustment unit 150, and the circulation pump 500) are simplified for a clearer description of the circulation path. FIG. 5 is a block diagram schematically illustrating the circulation path illustrated in FIG. 4 (note that illustration of the housing part is omitted in FIG. 5). As illustrated in FIGS. 4 and 5, the first pressure adjustment unit 120 includes a first valve chamber 121 and a first pressure control chamber 122. The second pressure adjustment unit 150 includes a second valve chamber 151 and a second pressure control chamber 152. The first pressure adjustment unit 120 is configured such that the controlled pressure therein is higher than that in the second pressure adjustment unit 150. In the present embodiment, these two pressure adjustment units 120 and 150 are used to implement circulation within a certain pressure range inside the circulation path. Also, the configuration is such that the ink flows through pressure chambers 12 at a flow rate corresponding to the pressure difference between the first pressure adjustment unit 120 and the second pressure adjustment unit 150. A circulation path in the liquid ejection head 1 and a flow of the ink in the circulation path will be described below with reference to FIGS. 4 and 5. Note that in FIGS. 4 and 5, the portion illustrated as the liquid circulation unit 54 is one liquid circulation unit (e.g., the individual liquid circulation unit 54a or the like) in the liquid ejection head according to the present disclosure, and the portions illustrated as the housing 110 and the ejection unit 300 are the portions for this one liquid circulation unit. Moreover, in each of FIGS. 4 and 5, the arrows depicted inside the liquid ejection head 1 indicate the direction in which the liquid (ink) flows.

First, how constituent elements are connected inside the liquid ejection head 1 will be described. The liquid ejection head 1 includes an ink tank 2 and an external pump 21 on the outside thereof. The external pump 21 sends the ink stored in the ink tank 2 (see FIG. 5) to the liquid ejection head 1. The external pump 21 is connected to the liquid circulation unit 54 through the guide (ink supply tube) 59 (see FIGS. 1A and 1B). The ink channel (inflow channel) located on an upstream side of the liquid circulation unit 54 is provided with the filter 23. The ink supply path (inflow channel) located downstream of the filter 23 is connected to the first valve chamber 121 of the first pressure adjustment unit 120. The first valve chamber 121 communicates with the first pressure control chamber 122 through a communication port 191A openable and closable by a valve 190A illustrated in FIG. 4. Note that the inflow channel is a channel through which the liquid in the ink tank 2 provided outside the liquid ejection head 1 flows into the liquid ejection head 1 to be supplied to the pressure chambers 12.

The first pressure control chamber 122 is connected to a supply channel 130, a bypass channel 160, and a pump outlet channel 180 of the circulation pump 500. The supply channel 130 is connected to a common supply channel 18 in the ejection unit 300 through a supply port (ink supply port) 410 provided in the liquid circulation unit and a first channel (the first channel 650 in FIG. 6) in the housing 110 (the first channel 650 serves as a channel for supplying the liquid to the ejection unit 300). Also, the bypass channel 160 is connected to the second valve chamber 151 provided in the second pressure adjustment unit 150. The second valve chamber 151 communicates with the second pressure control chamber 152 through a communication port 191B that is opened and closed by a valve 190B illustrated in FIG. 4. Note that FIGS. 4 and 5 illustrate an example where one end of the bypass channel 160 is connected to the first pressure control chamber 122 of the first pressure adjustment unit 120, and the other end of the bypass channel 160 is connected to the second valve chamber 151 of the second pressure adjustment unit 150. However, the one end of the bypass channel 160 may be connected to the supply channel 130, and the other end of the bypass channel may be connected to the second valve chamber 151.

The second pressure control chamber 152 is connected to a collection channel 140. The collection channel 140 is connected to a second channel (the second channel 652 in FIG. 6) in the housing 110 and a common collection channel 19 in the ejection unit 300 through a collection port 412 (ink collection port) provided in the liquid circulation unit (the second channel 652 serves as a channel for collecting the liquid from the ejection unit 300). Note that the supply channel 130 and the collection channel 140 are included in the liquid circulation unit, and the first channel 650 and the second channel 652 of the housing 110 are included in a channel member 520. Moreover, the second pressure control chamber 152 is connected to the circulation pump 500 through a pump inlet channel 170.

Next, the flow of an ink inside the liquid ejection head 1 having the above configuration will be described. The ink supplied to the liquid circulation unit 54 passes through the filter 23, so that foreign substances such as dust and bubbles are removed. The ink then flows into the first valve chamber 121 provided in the first pressure adjustment unit 120. The pressure on the ink drops due to the pressure loss by the passage through the filter 23, but the pressure on the ink is still positive at this point. Thereafter, in a case where the valve 190A is open, the ink having flowed into the first valve chamber 121 passes through the communication port 191A and flows into the first pressure control chamber 122. Due to the pressure loss by the passage through the communication port 191A, the pressure on the ink having flowed into the first pressure control chamber 122 switches from the positive pressure to a negative pressure. Next, the flow of the ink in the circulation path will be described. The circulation pump 500 operates to send the ink, which the pump has sucked in from the pump inlet channel 170 located upstream of the pump, to the pump outlet channel 180 located downstream of the pump. Thus, as the pump is driven, the ink supplied to the first pressure control chamber 122 flows into the supply channel 130 and the bypass channel 160 along with the ink sent from the pump outlet channel 180.

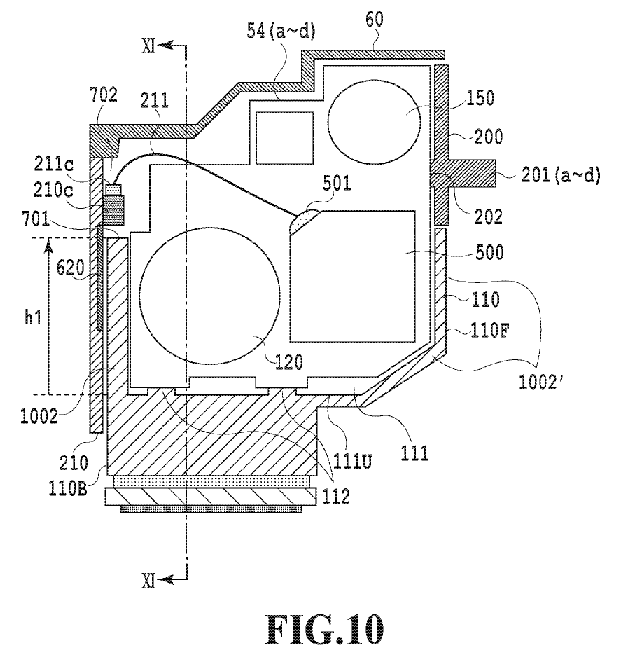

In the present embodiment, a piezoelectric diaphragm pump using a piezoelectric element attached to a diaphragm as a driving source is used as the circulation pump 500 capable of sending the liquid. The piezoelectric diaphragm pump is a pump that sends a liquid by inputting a driving voltage to a piezoelectric element to change the inner volume of a pump chamber and causing two check valves to alternately move with the change in pressure. A circulation pump driving circuit supplies the driving voltage to the circulation pump 500 through a harness wiring 211 (see FIG. 6). The piezoelectric diaphragm is disposed inside the circulation pump 500, and the harness wiring 211 for inputting the voltage from the driving circuit is connected to the piezoelectric diaphragm. For this reason, the circulation pump 500 includes an opening portion for the harness wiring 211 connected to the piezoelectric diaphragm. At this opening portion, a sealing portion 501 (see FIG. 10) is provided. The sealing portion covers the opening portion with a sealing member in order to prevent entry of an ink from the outside.

The ink having flowed into the supply channel 130 passes through the first channel (the first channel 650 in FIG. 6) in the housing 110 from the supply port 410 and flows into the common supply channel 18 from an ink supply port in the ejection unit 300. The ink then flows into the pressure chambers 12 through the common supply channel 18. Part of this ink that has flowed in is ejected from ejection orifices 13 by driving ejection energy generation elements (heating elements) 15 in the ejection element 310. The remaining ink, which was not ejected, flows through the pressure chambers 12 and passes through the common collection channel 19. Thereafter, the ink passes through the second channel (the second channel 652 in FIG. 6) in the housing connected to the ejection unit 300 and the collection port 412 and flows into the collection channel 140. The ink having flowed into the collection channel 140 flows into the second pressure control chamber 152 of the second pressure adjustment unit 150. On the other hand, the ink having flowed into the bypass channel 160 from the first pressure control chamber 122 flows into the second valve chamber 151 and then passes through the communication port 191B to flow into the second pressure control chamber 152. The ink having flowed into the second pressure control chamber 152 through the bypass channel 160 and the ink collected from the collection channel 140 are sucked into the circulation pump 500 as the circulation pump 500 is driven. The suction is performed through the pump inlet channel 170 from an inlet 170a of the pump inlet channel 170 provided in the second pressure control chamber 152. Then, the inks sucked into the circulation pump 500 are sent to the pump outlet channel 180 and flow into the first pressure control chamber 122 again. Thereafter, the ink flowing into the second pressure control chamber 152 from the first pressure control chamber 122 through the supply channel 130 and the ejection unit 300 and the ink flowing into the second pressure control chamber 152 through the bypass channel 160 will flow into the circulation pump 500. The inks are then sent from the circulation pump 500 to the first pressure control chamber 122. The ink circulation is performed within the circulation path in this manner.

As described above, in the present embodiment, the liquids can be circulated through the respective circulation paths formed in the liquid ejection head 1 with the respective circulation pumps 500. Such a configuration can prevent or reduce thickening of the inks inside the ejection unit 300 and deposition of precipitating components of the inks such as their color materials. Accordingly, the fluidity of the inks in the ejection unit 300 and ejection characteristics at the ejection orifices can be maintained well.

### Description of Circulation Pump Driving Circuit

FIG. 6 is a schematic diagram illustrating an electrical connection configuration for driving a circulation pump. A driving signal is sent from the CPU 400 mounted on a main circuit board 230 inside the liquid ejection apparatus to a carriage board 220 inside the carriage 53 through a flexible flat cable (FFC). Further, the driving signal is sent from the carriage board 220 to the head electric substrate 210 through a connecting portion 212 establishing a contact connection. Here, the head electric substrate 210 incorporates a control chip, a booster circuit, and a divider circuit. In response to receiving a driving signal, the control chip outputs a boost signal to drive the booster circuit. Here, a 5-V input voltage is boosted to 66 V. Boosting the voltage to 66 V makes it possible to efficiently discharge air inside the circulation pump 500. The boosted voltage is output to the circulation pump 500 through the harness wiring 211. As a result, the circulation pump 500 is driven and circulates the liquid. As described above using FIGS. 4 and 5, the liquid (ink) is supplied to the common supply channel 18 in the ejection unit 300 from the first channel 650 in the housing 110 through the supply port 410 in the liquid circulation unit. Then, the liquid (ink) flows through the pressure chambers 12, and part of the liquid (ink) is ejected from the ejection orifices 13. Also, the remaining liquid (ink), which was not ejected, flows into the circulation unit 54 through the second channel 652 in the housing 110 connected to the ejection unit 300 and the collection port 412 in the liquid circulation unit.

### Description of Flame-retarding Measure for High-voltage Wirings

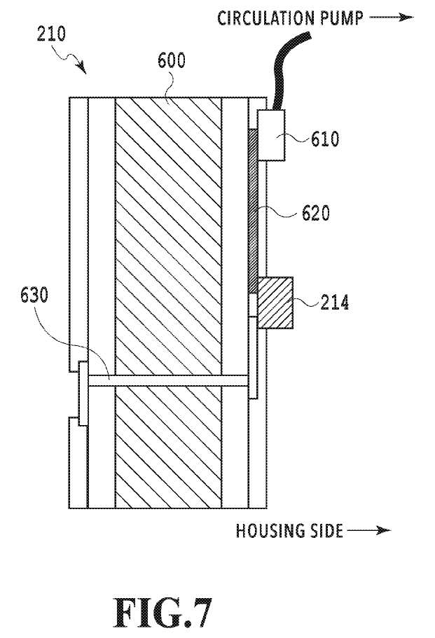

FIG. 7 is a cross-sectional view of the head electric substrate 210. A high-voltage portion 620 including high-voltage wirings is located on the side of the head electric substrate 210 closer to the housing of the liquid ejection head 1 (on the side indicated as "housing side" in FIG. 6) with respect to a core member 600 of the head electric substrate 210, which is a flame-retardant member. A current supplied from the main body is connected to a booster circuit 214 of the head electric substrate 210 through a via hole 630, so that the voltage is boosted. The high-voltage portion 620, which is arranged in a two-dimensional plane, is connected to the circulation pump through a connector 610, allowing the circulation pump 500 to be driven. The connector 610 connects the harness wiring 211 from the circulation pump 500 to the high-voltage portion 620 by a pump-side connector 211c of the harness wiring 211 and an electric substrate connector 210c of the head electric substrate 210 (see FIG. 10 and other drawings). As described above, in the present embodiment, the booster circuit 214 boosts the voltage to 66 V in order to efficiently discharge air inside the circulation pump 500. Thus, a high voltage of 66 V is applied to the high-voltage portion 620. According to an international safety standard (ICE60950-1), voltages above 42.4 V are dangerous voltages. Hence, in the present embodiment, it is necessary to keep the user from touching the high-voltage portion 620, to which 66 V is applied. Further, the high-voltage portion 620, which can be an ignition source, needs a flame-retarding measure in case it ignites or smokes. In the present embodiment, the high-voltage portion 620 is disposed on the side of the head electric substrate 210 closer to the housing of the liquid ejection head 1 with respect to the core member 600 (on the side indicated as "housing side" in FIG. 6). For this reason, only the housing side of the head electric substrate 210 needs a flame-retarding measure. Here, in the description of the circulation pump driving circuit given above, the liquid ejection head according to the present disclosure is boosted to 66 V by the head electric substrate 210. However, in compliance with the international safety standard mentioned above, the head electric substrate 210 of the liquid ejection head according to the present disclosure may be a high-voltage portion including high-voltage wirings to which a voltage of at least 42.4 V or higher can be applied.

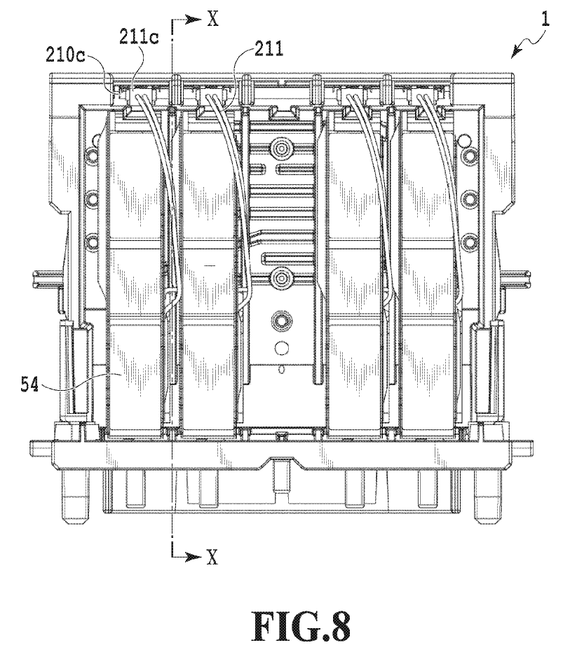

The flame-retarding measure of the liquid ejection head will now be described further with reference to FIGS. 8 and 10. FIG. 8 is a top view of the liquid ejection head 1. FIG. 8 illustrates a state where each liquid circulation unit 54 is mounted in a concave portion 111 of the housing 110, and the pump-side connector 211c of the corresponding harness wiring 211 is connected to the corresponding electric substrate connector 210c. As illustrated in FIG. 8, on the concave portion 111 side of the head electric substrate 210, there is an electric connection portion for connecting the circulation pump 500 and the high-voltage portion 620 (a portion including the electric substrate connector 210c and the pump-side connector 211c). FIG. 10 is a cross-sectional view taken along line X-X in FIG. 8. As illustrated in FIG. 10, the high-voltage portion 620 in the surface of the head electric substrate 210 on the housing side is covered by the core member of the head electric substrate 210 itself, the housing 110, the head cover 60, and the joint member 200 in such a way as to be screened from the outside. Moreover, those members can be flame-retardant members. This configuration suppresses spread of fire from an ignition source caused by the high-voltage portion 620.

### Internal Configuration of Liquid Ejection Head

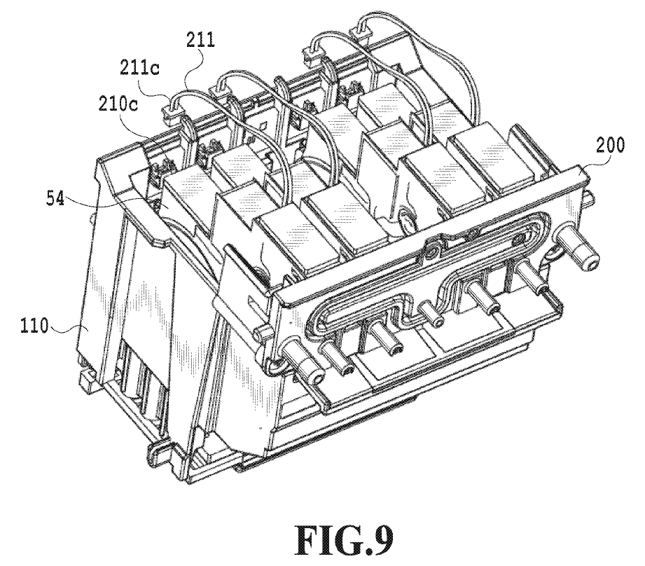

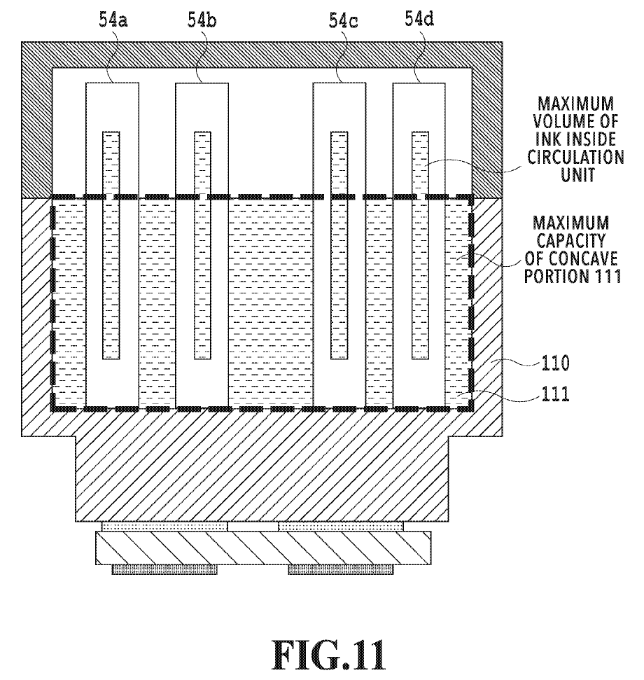

Next, an internal configuration of the liquid ejection head 1 will be described with reference to FIGS. 9, 10, and 11. FIG. 9 is a perspective view illustrating an upper portion of the liquid ejection head 1 with the head cover 60 detached. FIG. 10 is a cross-sectional view taken along line X-X in FIG. 8. FIG. 11 is a cross-sectional view along line XI-XI in FIG. 10. First of all, as illustrated in FIG. 10, the liquid circulation unit 54 is disposed in the concave portion 111, which is a space formed by the housing 110 and the head cover 60. The housing 110 includes a first side surface 110B and a second side surface 110F. The concave portion 111 includes at least a side wall 1002 (a side wall on the first side surface 110B side of the housing 110) and a side wall 1002' (a side wall on the second side surface 110F side of the housing 110). In the liquid ejection head according to the present disclosure, the height of the circulation units can be greater than the height of the side walls 1002 and 1002' of the housing 110, as illustrated in FIG. 10.

The joint member 200 will be described. The joint member 200 is fixed to the second side surface 110F by screwing or the like. As illustrated in FIG. 10, each liquid circulation unit 54 is connected to the housing 110 at connection portions 112 and connected to the joint member 200 at a connection portion 202. A seal member (not illustrated) is interposed between the liquid circulation unit 54 and the joint member 200 to seal the connection portion 202 of the joint member 200. Similarly, a seal member (not illustrated) is interposed between the liquid circulation unit 54 and the housing 110 to seal the connection portions 112 of the housing 110.

The connection portions 112 of the housing 110 and the connection portion 202 of the joint member 200 can be sealed by configurations as below, for example.

For the sealing between the liquid circulation unit 54 and the housing 110, an O-ring press-fitting method may be employed in which one of them has a convex shape while the other has a concave shape, and the convex shape is inserted into the concave shape with the outer periphery of the convex shape and the inner periphery of the concave shape squeezing a seal member, such as an O-ring, interposed therebetween. Alternatively, a seal configuration may be employed in which a seal member is sandwiched between the bottom surface of the liquid circulation unit 54 and the surfaces of the connection portions 112 of the housing 110 facing the bottom surface of the liquid circulation unit 54, and the seal member is squeezed by screwing.

The sealing between the liquid circulation unit 54 and the joint member 200 can be performed similarly to the sealing between the liquid circulation unit 54 and the housing 110. Specifically, for the sealing in this case, an O-ring press-fitting method can be employed in which, for example, firstly one of the liquid circulation unit 54 or the joint member 200 is formed in a convex shape while the other is formed in a concave shape, and the convex shape is inserted into the concave shape with the outer periphery of the convex shape and the inner periphery of the concave shape squeezing a seal member, such as an O-ring, interposed therebetween to achieve sealing. Alternatively, a seal configuration can be employed in which a seal member is sandwiched between the liquid circulation unit 54 and the joint member 200 at the position at which the liquid circulation unit 54 and the joint member 200 are to be connected (the connection portion 202), and they are connected with the seal member squeezed therebetween by screwing.

Further, the head cover 60 is present above the liquid circulation unit 54, and the head cover 60 can be fixed to the housing 110 at a portion where they are engaged with each other (not illustrated).

Next, configurations of the housing 110 and the head electric substrate 210 will be described. The housing 110 includes the surface 110F on the joint member 200 side (second side surface) and the surface 110B on the opposite side, or the first side surface 110B. The head electric substrate 210 is mounted to the first side surface 110B. As described earlier, the high-voltage portion 620 is disposed in the surface of the head electric substrate 210 on the housing 110 side to keep the user from touching the high-voltage portion. The electric substrate connectors 210c for electrically connecting the circulation pumps 500 of the liquid circulation units 54 and the high-voltage portion 620 are disposed on the surface of the head electric substrate 210 on the housing 110 side. More specifically, as described earlier, the concave portion 111 of the housing 110 includes at least the side wall 1002 (the side wall on the first side surface 110B side of the housing 110) and the side wall 1002' (the side wall on the second side surface 110F side of the housing 110). The head electric substrate 210 is disposed on the outer surface of the side wall 1002 of the concave portion 111 (see FIG. 10). In other words, the head electric substrate 210 is mounted facing the first side surface 110B of the side wall 1002.

As illustrated in FIG. 9, the liquid circulation units 54 (the individual liquid circulation units 54a to 54d) each include a harness wiring 211 connected to the corresponding circulation pump 500 and including a pump-side connector 211c at the tip. By connecting each pump-side connector 211c and the corresponding electric substrate connector 210c, the high-voltage portion 620 arranged in the head electric substrate 210 and each circulation pump 500 are electrically connected. The electric connection portion (a portion including the electric substrate connector 210c and the pump-side connector 211c) is a portion to which a high voltage is applied, like a high-voltage circuit, and it is therefore necessary to keep the user from touching it. For this reason, the electric connection portion is disposed inside the housing 110 (inside the concave portion). To allow the electric substrate connector 210c and the pump-side connector 211c to be connected inside the housing 110, a communication portion 702 for establishing an electrical connection is formed between the head electric substrate 210 and the outer surface of the side wall 1002 of the concave portion 111 (first side surface 110B). As described above, the head electric substrate 210 is provided facing the outer surface of the concave portion 111 on the side wall 1002 side (first side surface 110B). For this reason, the communication portion 702 is located higher than (located on the head cover 60 side relative to) this side wall. This communication portion allows communication between the concave portion 111 and the head electric substrate 210 side. Accordingly, as illustrated in FIG. 10, the above-described electric connection portion including the electric substrate connector 210c and the pump-side connector 211c is provided on the head cover 60 side relative to an upper end 701 of the side wall 1002 (that is, the electric connection portion is located higher than the upper end of the side wall 1002). Note that the electric connection portion may be disposed inside the communication portion 702 as illustrated in FIG. 10. Alternatively, the electric connection portion may be disposed in the space on the opposite side of the side wall 1002 from the inside of the concave portion 111 (the space between the head electric substrate 210 and the side wall 1002).

Next, the height of the side wall 1002 will be described using FIG. 10 and FIG. 11 being a cross-sectional view taken along line XI-XI in FIG. 10. As illustrated in FIG. 10, the height of the concave portion 111 from a housing bottom surface 111U to the upper end 701 of the side wall 1002 is defined as h1. In other words, the side wall 1002 has a height from the upper end 701 to the housing bottom surface 111U of the concave portion 111 (h1). The housing 110 of the liquid ejection head according to the present disclosure is desirably configured such that the height of the upper end of the side wall 1002 of the concave portion 111 (h1) is such that, even in case of leakage of all inks from the liquid circulation units 54, the leaked inks will not reach the communication portion 702 and flow out to the head electric substrate 210 side through the communication portion 702. Such a configuration prevents ignition and smoking due to attachment of the inks to the high-voltage portion 620. Further, as illustrated in FIG. 10, each circulation pump 500 is provided with a sealing portion 501 sealing an opening therein. This sealing portion 501 is desirably disposed at a position higher than the height h1. Such a configuration more reliably blocks entry of inks into the circulation pump 500 and prevents attachment of the inks to the portions of the piezoelectric diaphragm and the harness wiring 211 at which they are electrically connected.

Next, the amount of liquid containable in the concave portion 111 will be described with reference to FIG. 11. In the liquid ejection head according to the present disclosure, the maximum capacity of the concave portion 111 is desirably set such that, even in a case where liquids such as the inks leak out, the inks will not flow out to the head electric substrate 210 side. The maximum volume of liquid containable in the concave portion 111 can be derived by the following method, for example. In a use state in which the liquid ejection head is set in a posture for use and components (such as the circulation units) are arranged for use, a liquid is poured into the concave portion using a tool that can measure volumes, such as a beaker. The amount of the liquid poured up to the point when the poured liquid starts leaking out of the concave portion over the side wall is the maximum volume of liquid containable in the concave portion. Specifically, the inner volume of the portion surrounded by the dashed line in FIG. 11 excluding the inner volumes of the portions corresponding to the regions of the liquid circulation units 54a to 54d within the dashed line is the maximum volume of liquid containable in the concave portion. Note that the maximum volume of liquid containable in the concave portion can be derived by a calculation instead of a manual method as described above.

In the liquid ejection head according to the present disclosure, the maximum volume of liquid containable in the concave portion is greater than the volume of liquid containable in the entireties of the liquid circulation units. The volume of liquid containable in the entireties of the liquid circulation units refers to the volume of the liquids contained in the whole channels connecting the supply ports 410 and the collection ports 412 (see FIG. 4, for example) of the respective liquid circulation units 54 through the respective pumps (third channel).

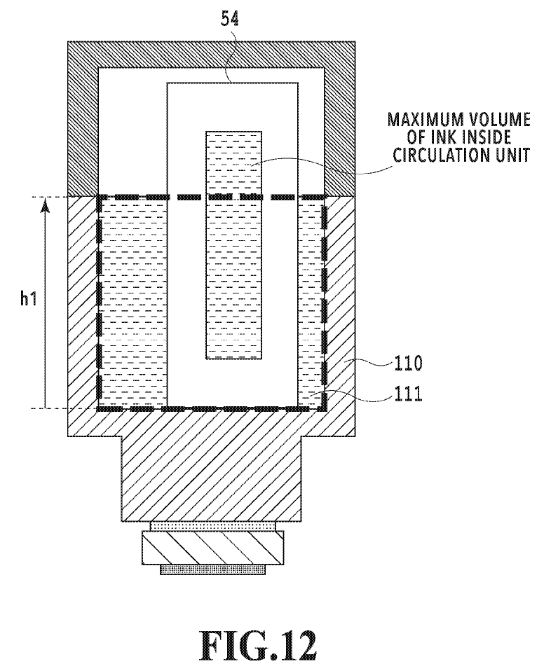

Here, in a case where there are four liquid circulation units 54a to 54d as illustrated in FIG. 11, the volume of liquid containable in the entireties of the liquid circulation units is the amount of liquid corresponding to the sum of the maximum amounts of liquid containable in the four liquid circulation units. As described above, multiple liquid circulation units (four liquid circulation units in the above example) may be accommodated in the concave portion of the liquid ejection head according to the present disclosure. While multiple liquid circulation units are mounted on the liquid ejection head according to the present disclosure, there may be only one liquid circulation unit 54, as illustrated in FIG. 12. In this case, the inner volume of the portion surrounded by the dashed line in FIG. 12 excluding the inner volume of the portion of the one liquid circulation unit (e.g., the liquid circulation unit 54a) within the dashed line is the maximum volume of liquid containable in the concave portion. Moreover, the maximum volume of liquid containable in the concave portion is a volume greater than the maximum volume of liquid containable in the one liquid circulation unit.

It is also necessary to consider reducing constraints on the design of the liquid circulation units 54 as much as possible. For example, it is necessary to consider increasing the inner volumes of the pressure control portions (first pressure control chamber and second pressure control chamber) in order to reduce the variation in the pressures in the pressure control portions (first pressure control chamber and second pressure control chamber). In view of this, it is desirable that the maximum volume of liquid containable in the concave portion 111 in a use state as described earlier be 10 cc or more. Also, in a case where the liquid ejection head 1 is taken out in a state where the inks in the multiple individual liquid circulation units 54a to 54d of the liquid circulation unit 54 have leaked out and accumulated in the concave portion 111, even a slight shake or the like causes sloshing of the inks having leaked out into the concave portion. In one embodiment, to prevent the inks from flowing out through the communication portion 702 in such a case, the value of the maximum volume of liquid containable in the concave portion 111 in a use state as described earlier can be set to approximately 80 cc. In addition, in another embodiment, the maximum volume of liquid containable in the concave portion 111 in a use state as described earlier can be in the range of approximately 10 cc to approximately 80 cc.

Furthermore, it is desirable that the sealing portion 501 sealing an opening in the circulation pump 500 be disposed at a position higher than the height h1, as illustrated in FIG. 10. Such a configuration more reliably blocks entry of inks into the circulation pump 500 and prevents attachment of the inks to the portions of the piezoelectric diaphragm and the harness wiring 211 at which they are electrically connected.

### Second Embodiment

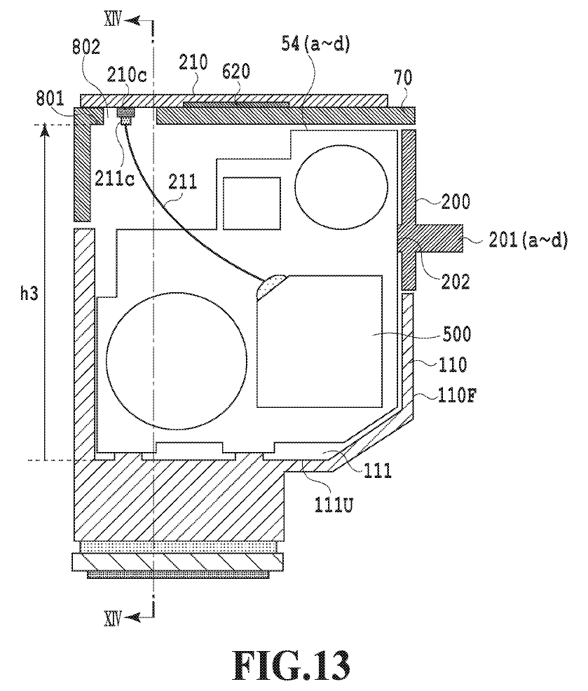

FIG. 13 illustrates a second embodiment of the present disclosure. FIG. 13 is a schematic cross-sectional view of a liquid ejection head 1 in the second embodiment. As illustrated in FIG. 13, in the liquid ejection head 1 in the present embodiment, the head electric substrate 210 is disposed on the upper surface of a head cover 70 (the surface on the opposite side from the side where the concave portion 111 is present). The head cover 70 can be flat so that the head electric substrate 210 can be arranged thereon, as illustrated in FIG. 13, but the shape of the head cover 70 is not limited to this. The high-voltage portion 620 in the head electric substrate 210 is disposed in the surface of the head electric substrate 210 on the side facing the upper surface of the head cover 70. As illustrated in FIG. 13, the internal space formed by the housing 110, the joint member 200, and the head cover 70 is the concave portion 111 for the liquid circulation units 54. In the head cover 70, a communication portion 802 for connecting the electric substrate connectors 210c on the head electric substrate 210 side and the respective pump-side connectors 211c on the liquid circulation unit 54 side is formed. This communication portion 802 is formed such that the electric substrate connectors 210c and the pump-side connectors 211c do not enter the concave portion 111 side beyond a lower end 801 of the head cover 70. That is, the communication portion 802 is formed such that the electric substrate connectors 210c and the pump-side connectors 211c do not project to the concave portion side beyond the head cover 70.

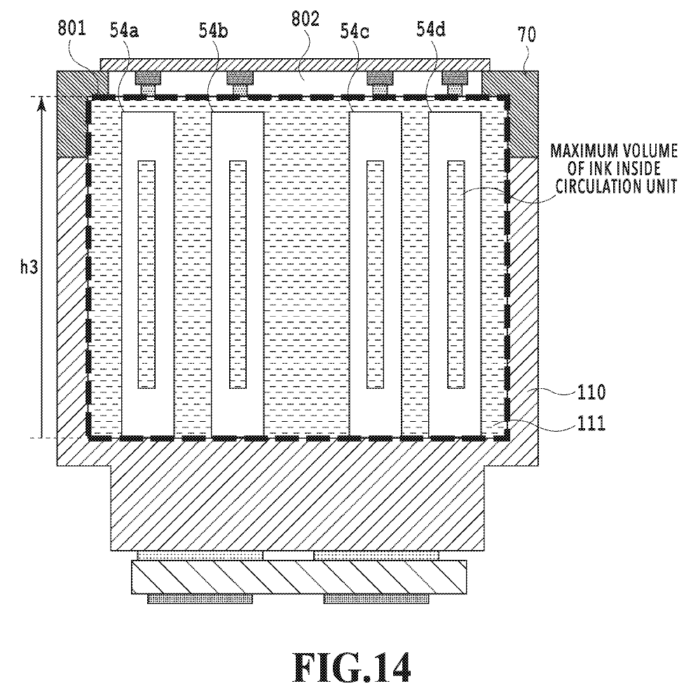

As illustrated in FIG. 14, the height from the housing bottom surface 111U of the concave portion 111 to the head cover 70 is h3. In the present embodiment, the inner volume of the region formed by the head cover 70 and the concave portion 111 can be larger than the volume of the liquids inside the entireties of the liquid circulation units 54. The concave portion 111 of the housing 110 of the liquid ejection head according to the present disclosure is desirably formed such that even in case of leakage of all inks from the liquid circulation units 54, the leaked inks will not reach the head cover 70 and flow out to the head electric substrate 210 side through the communication portion 802. Such a configuration prevents ignition and smoking due to attachment of the inks to the high-voltage portion 620.

Next, the amount of liquid containable in the concave portion 111 will be described with reference to FIG. 14. In the liquid ejection head according to the present disclosure, the maximum capacity of the concave portion 111 is desirably set such that, even in a case where liquids such as the inks leak out, the inks will not flow out to the side of the head cover where the head electric substrate 210 is present. The maximum volume of liquid containable in the concave portion 111 can be derived by the following method, for example. In a use state in which the liquid ejection head is set in a posture for use and components (such as the circulation units) are arranged for use, a liquid is poured into the concave portion using a tool that can measure volumes, such as a beaker. The amount of the liquid poured up to the point when the poured liquid starts spilling over the head cover is the maximum volume of liquid containable in the concave portion. Specifically, the inner volume of the portion surrounded by the dashed line in FIG. 14 excluding the inner volumes of the portions of the liquid circulation units 54a to 54d within the dashed line (the inner volume of the entireties of the four circulation units) is the maximum volume of liquid containable in the concave portion. Note that the maximum volume of liquid containable in the concave portion can be derived by a calculation instead of a manual method as described above.

In the liquid ejection head according to the present disclosure, the maximum volume of liquid containable in the concave portion is greater than the volume of liquid containable in the entireties of the liquid circulation units. The volume of liquid containable in the entireties of the liquid circulation units refers to the volume of the liquids contained in the whole channels connecting the supply ports 410 and the collection ports 412 (see FIG. 4, for example) of the respective liquid circulation units 54 through the respective pumps (third channel).

Here, in a case where there are four liquid circulation units 54a to 54d as illustrated in FIG. 14, the volume of liquid containable in the entireties of the liquid circulation units is the amount of liquid corresponding to the sum of the maximum amounts of liquid containable in the four liquid circulation units. In the present embodiment, a case where multiple liquid circulation units (four liquid circulation units in the above example) are accommodated the concave portion has been described. However, in the first embodiment, the liquid ejection head according to the present disclosure may include only one liquid circulation unit 54, as has been described using FIG. 12. In this case, the inner volume of the portion surrounded by the dashed line in FIG. 14 excluding the inner volume of the entirety of the one liquid circulation unit (e.g., the liquid circulation unit 54a) is the maximum volume of liquid containable in the concave portion. Moreover, the maximum volume of liquid containable in the concave portion is a volume greater than the maximum volume of liquid containable in the one liquid circulation unit.

Another mode of the present embodiment will be described below. This other embodiment represents a mode in which a partition wall is provided between the head cover 70 and the concave portion 111.

In the present embodiment, the partition wall is provided between the head cover and the position of the ceiling portion of the concave portion 111. The partition wall may be a separate member interposed between the concave portion 111 of the housing 110 and the head cover. In the present embodiment, the head electric substrate 210 is provided between the inner side of the head cover (the housing 110 side) and the partition wall. Thus, the partition wall separates the concave portion 111 and the head electric substrate 210. The high-voltage portion 620 of the head electric substrate 210 is disposed in the surface of the head electric substrate 210 on the side facing the upper surface of the partition wall (head cover side). That is, the high-voltage portion 620 is disposed in the surface of the head electric substrate 210 on the partition wall side. In the partition wall, a communication portion for connecting the electric substrate connectors 210c on the head electric substrate 210 side and the respective pump-side connectors 211c on the liquid circulation unit 54 side is formed. This communication portion of the partition wall is formed such that the electric substrate connectors 210c and the pump-side connectors 211c do not enter the concave portion side from the communication portion. That is, the communication portion is formed such that the electric substrate connectors 210c and the pump-side connectors 211c do not project to the concave portion side beyond the partition wall.

In the present embodiment, the height from the housing-side bottom surface 111U of the concave portion 111 to the surface of the partition wall on the concave portion side is h3. In the liquid ejection head according to the present disclosure, the inner volume of the region formed by the partition wall and the concave portion 111 is larger than the volume of the liquids in the liquid circulation units. In this modification too, the maximum volume of liquid containable in the concave portion 111 can be derived by the method described in the present embodiment. By employing a configuration as described above, even in a case where inks leak out of the liquid circulation units 54 inside the concave portion 111, the inks will be kept from entering the communication portion, preventing contact between the inks and the high-voltage portion 620. As described above, the configuration is such that a partition wall is provided between the head cover 70 and the concave portion, and the head electric substrate 210 is disposed between this partition wall and the head cover. In this way, in a case where inks leak out of the liquid circulation units 54 into the concave portion 111, the leaked inks are unlikely to flow out to the head electric substrate 210 side, making it possible to keep the inks from getting attached to the high-voltage portion 620. As a result, ignition and smoking will be prevented.

### Third Embodiment

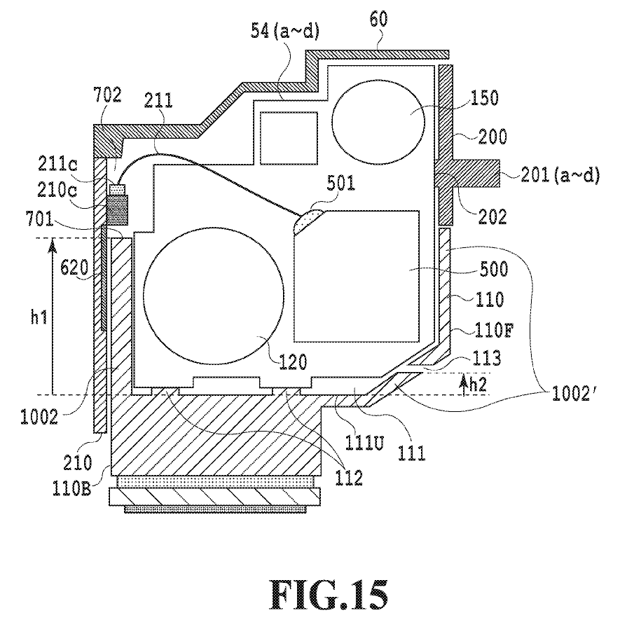

A third embodiment of the present disclosure will now be described with reference to FIG. 15. The third embodiment involves forming a discharge port 113 in the bottom surface or side wall of the concave portion of the housing 110 in the first embodiment.

As illustrated in FIG. 15, the discharge port 113 for discharging inks is provided in the housing 110 on the opposite side from the head electric substrate 210 (the side wall 1002' side) at a height h2 smaller than the maximum height h1. Providing the discharge port 113 on the opposite side from the head electric substrate 210 at a position lower than the upper end 701 of the communication portion 702 allows leaked inks to be discharged to the outside before reaching the communication portion 702. Note that the opening size of the discharge port 113 cannot be very large in order to prevent spread of fire to the outside in a case where the high-voltage portion ignites and smokes due to an unexpected event other than the ink leakage. For this reason, it is desirable that the opening size of the discharge port 113 have a diameter (φ) of approximately 0.8 mm or more and 1.2 mm or less. As described above, the opening size of the discharge port 113 cannot be very large. Thus, in a case where inks suddenly leak out, there is a possibility that the rate of discharge of the inks to the outside through the discharge port 113 is insufficient relative to the rate of leakage of the inks from the liquid circulation units 54 into the concave portion 111 of the housing 110 and the inks accordingly remain in the concave portion 111 to some extent. Furthermore, it is desirable that the sealing portion 501 sealing an opening in the circulation pump 500 be disposed at a position higher than the height h1. Such a configuration more reliably blocks entry of inks into the circulation pump 500 and prevents attachment of the inks to the portions of the piezoelectric diaphragm and the harness wiring 211 at which they are electrically connected.

In the present embodiment, an example in which the discharge port 113 is formed on the second side surface 110F side has been presented. However, in the liquid ejection head according to the present disclosure, although it is desirable to form the discharge port 113 on the second side surface 110F side, the discharge port 113 may be formed in any of the side faces of the concave portion 111, as long as the requirements for the discharge port described above are met.

The liquid ejection head according to the present disclosure brings about the advantageous effect described below. Specifically, in the configuration of the ink circulation apparatus in Patent Document 1 mentioned earlier, this apparatus' diaphragm pump is driven by a voltage modulated within the range of 120 V to 300 V with 200 V as an initial voltage. Thus, this apparatus uses a relatively high voltage to drive the diaphragm pump. One of factors that require a high voltage to drive the diaphragm pump is, for example, the presence of a large amount of air in the diaphragm pump chamber during the initial ink filling or the like. Specifically, driving the diaphragm pump with a low voltage can displace the diaphragm only to a small extent, making it difficult to generate a pressure inside the diaphragm pump chamber and discharge the air inside the pump chamber. For this reason, it is necessary to drive the diaphragm pump with a high voltage to displace the diaphragm to a large extent and make the pressure inside the pump chamber high so that the air can be discharged. In a case where a control unit with a driving circuit to which a relatively high voltage is applied as described above is mounted to be exposed to the outside, as with the ink circulation apparatus disclosed in Patent Document 1, there is a risk that the user may touch the high-voltage portion. In order to avoid such a risk, a configuration in which the high-voltage portion is arranged inside the liquid ejection head, instead of being disposed on the outer side of the liquid ejection head, to keep the user from touching the high-voltage portion is desirable. However, such a configuration requires a measure to keep inks leaking out inside the liquid ejection head from contacting the high-voltage portion. The present disclosure is advantageous to such a situation.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-021760, filed February 13, 2025 and Japanese Patent Application No. 2025-231133, filed December 4, 2025, which are hereby incorporated by reference herein in their entirety.

What is claimed is:

1. A liquid ejection head comprising:
a liquid ejection unit configured to eject a liquid;
a housing including a first channel for supplying the liquid to the liquid ejection unit and a second channel for collecting the liquid from the liquid ejection unit; and
a liquid circulation unit including
a supply port for supplying the liquid to the first channel,
a collection port for collecting the liquid from the second channel,
a pump configured to supply the liquid collected from the collection port to the supply port, and
a third channel connecting the supply port and the collection port via the pump, wherein
the housing includes a concave portion including a bottom surface and a side wall connected to the bottom surface,
the liquid circulation unit is disposed in the concave portion, and
a maximum volume of liquid containable in the concave portion in a use state of the liquid ejection head is larger than a volume of liquid containable in an entirety of the third channel of the liquid circulation unit.

2. The liquid ejection head according to claim 1, wherein
the liquid ejection head includes an electric substrate for driving the pump, and
the electric substrate is disposed on an outer surface of the side wall.

3. The liquid ejection head according to claim 2, wherein the electric substrate includes a high-voltage portion including a high-voltage wiring to which a voltage of 42.4 V or higher is applied.

4. The liquid ejection head according to claim 3, wherein the high-voltage portion is disposed at a surface of the electric substrate facing the outer surface of the side wall.

5. The liquid ejection head according to claim 1, wherein in the use state of the liquid ejection head, a portion of the liquid circulation unit is located higher than an upper end of the side wall.

6. The liquid ejection head according to claim 1,
further comprising a plurality of the liquid circulation units, and
the maximum volume of liquid containable in the concave portion in the use state of the liquid ejection head is larger than a volume of liquid containable in entireties of the third channels of the plurality of liquid circulation units.

7. The liquid ejection head according to claim 4, wherein the electric substrate includes an electric connection portion for connecting the pump and the high-voltage portion.

8. The liquid ejection head according to claim 7, wherein in the use state of the liquid ejection head, the electric connection portion is located higher than an upper end of the side wall.

9. The liquid ejection head according to claim 1, wherein the liquid circulation unit includes a plurality of pressure adjustment units.

10. The liquid ejection head according to claim 1, wherein the maximum volume of liquid containable in the concave portion in the use state of the liquid ejection head is 10 cc or more and 80 cc or less.

11. The liquid ejection head according to claim 1, further comprising an opening portion in the bottom surface or the side wall of the concave portion.

12. A liquid ejection apparatus comprising:
a liquid ejection head including
a liquid ejection unit configured to eject a liquid,
a housing including a first channel for supplying the liquid to the liquid ejection unit and a second channel for collecting the liquid from the liquid ejection unit, and
a liquid circulation unit including
a supply port for supplying the liquid to the first channel,
a collection port for collecting the liquid from the second channel,
a pump configured to supply the liquid collected from the collection port to the supply port, and
a third channel connecting the supply port and the collection port via the pump,
the housing including a concave portion including a bottom surface and a side wall connected to the bottom surface, wherein
the liquid circulation unit is disposed in the concave portion,
a maximum volume of liquid containable in the concave portion in a use state of the liquid ejection head is larger than a volume of liquid containable in an entirety of the third channel of the liquid circulation unit;
an ink tank provided outside the liquid ejection head; and
a pump provided outside the liquid ejection head and configured to supply the liquid from the ink tank to the liquid ejection head.
